(19) United States
(12) Patent Application Publication
(10) Pub. No.: US 2023/0255426 A1
(43) Pub. Date: Aug. 17, 2023

(54) CHARGING DEVICE FOR ROBOT CLEANER AND METHOD FOR CONTROLLING ROBOT CLEANER USING SAME

(71) Applicant: LG ELECTRONICS INC., Seoul (KR)

(72) Inventor: Byoungsuk CHOI, Seoul (KR)

(73) Assignee: LG ELECTRONICS INC., Seoul (KR)

(21) Appl. No.: 18/013,484

(22) PCT Filed: Dec. 9, 2020
(86) PCT No.: PCT/KR2020/017959

§ 371 Date: Dec. 28, 2022

(30) Foreign Application Priority Data
Jul. 2, 2020 (KR) 10-2020-0081414

(51) Int. Cl. A47L 9/28

(52) U.S. Cl. CPC A47L 9/2873; A47L 9/2805; A47L 2201/02

(57) ABSTRACT

The present disclosure relates to a charging device for a robot cleaner, and more particularly, to a charging device which is for a robot cleaner and includes: a main body that forms the exterior and is provided to charge a robot cleaner including a plurality of cliff detection sensors; and an arrangement plate that constitutes a lower part of the main body and has, on the upper surface, a charging terminal for charging the robot cleaner. A plurality of pads provided so that the robot cleaner receives different signals through the plurality of cliff detection sensors may be formed on the upper surface of the arrangement plate.

### TECHNICAL FIELD

The present disclosure relates to a robot cleaner charging device and a control method of a robot cleaner using the same. More particularly, the present disclosure relates to a robot cleaner charging device including pads having different colors or upper surfaces with different heights, and a control method of a robot cleaner using the robot cleaner charging device.

### BACKGROUND ART

In general, a robot cleaner is a cleaning device that sucks dust and a foreign substance from a floor surface while traveling a certain range of work areas without user manipulation, and a cleaning work is performed by determining the position of an obstacle or a wall through a sensor, a camera, or the like and avoiding the obstacle and the wall using the determined information while the robot cleaner travels.

After the cleaning work is performed, the robot cleaner moves to a robot cleaner charging device for charging, and according to a conventional robot cleaner control method, the robot cleaner receives an IR signal transmitted from the robot cleaner charging device and moves.

However, since the robot cleaner control method using the IR signal is greatly affected by indoor lighting, sunlight, etc., it is difficult to control a detailed operation of the robot cleaner, and the intensity of the IR signal has the maximum intensity and it is impossible to distinguish a specific area of the robot cleaner charging device in a state in which the robot cleaner and the robot cleaner charging device are close to each other, and accordingly, there is a disadvantage in that docking for charging the robot cleaner and the robot cleaner charging device is not precisely performed.

In this regard, Korean Patent Publication 20080022343 A (hereinafter referred to as Cited Reference 1) discloses that cliff recognition markers are installed on both left and right sides of an array plate of the robot cleaner charging device, and the robot cleaner recognizes a docking position of the robot cleaner and correcting an entry direction by detecting the cliff recognition markers through the cliff recognition markers through a cliff detection sensor. However, in the Cited Reference 1, since the cliff recognition marker is installed on a small part of the array plate, it is disadvantageously difficult to estimate and correct the position of the robot cleaner when the robot cleaner enters the robot cleaner charging device.

Korean Patent Publication 20180079054 A (hereinafter referred to as Cited Reference 2) discloses that the robot cleaner is docked to the robot cleaner charging device at a close distance through the patterns and the 3D sensor by applying black and white color patterns to a front surface of a robot cleaner charging device and applying a 3D sensor including an IR line laser and a camera to the robot cleaner. However, in the Cited Reference 2, since the 3D sensor applied to the robot cleaner requires high cost and the patterns need to be applied to all front surfaces of the robot cleaner charging device, inefficient cost expenditure is disadvantageously required.

### DISCLOSURE

### Technical Problem

One of various objects of the present disclosure is to provide a robot cleaner charging device for providing detailed motion control of a robot cleaner using a cliff detection sensor.

One of various objects of the present disclosure is to provide a robot cleaner charging device including pads that allow a robot cleaner to receive different signals through a cliff detection sensor.

One of various objects of the present disclosure is to provide a control method of a robot cleaner using a robot cleaner charging device including two types of pads that induce a cliff detection sensor included in a robot cleaner to receive different signals.

### Technical Solution

According to exemplary embodiments of the present disclosure, a control method of a robot cleaner includes a first operation in which a robot cleaner including a plurality of cliff detection sensors approaches the robot cleaner charging device according to an IR signal transmitted from a charging terminal for charging the robot cleaner, a second operation of checking whether a shortest distance between the robot cleaner and the robot cleaner charging device is equal to or less than a first distance, a third operation of checking whether center lines of the robot cleaner and the robot cleaner charging device are aligned through the plurality of cliff detection sensors and aligning the center lines of the robot cleaner and the robot cleaner charging device, and a fourth operation in which the robot cleaner moves straight toward the robot cleaner charging device when the center lines of the robot cleaner and the robot cleaner charging device are aligned.

The control method of the robot cleaner may further include a fifth operation of checking whether the minimum distance between the robot cleaner and the robot cleaner charging device is equal to or less than a second distance smaller than the first distance in a state in which the center lines of the robot cleaner and the robot cleaner charging device are aligned, a sixth operation of checking whether a difference in direction angle occurs between the robot cleaner and the robot cleaner charging device through the plurality of cliff detection sensors and correcting the difference in direction angle between the robot cleaner and the robot cleaner charging device, and a seventh operation in which the robot cleaner and the charging terminal come into contact when the direction angles of the robot cleaner and the robot cleaner charging device are corrected.

According to exemplary embodiments of the present disclosure, a robot cleaner charging device includes a main body defining an outer appearance and provided to charge a robot cleaner including a plurality of cliff detection sensors, and an array plate defining a lower part of the main body and having an upper surface on which a charging terminal for charging the robot cleaner is provided, wherein a plurality of pads provided to allow the robot cleaner to receive different signals through the plurality of cliff detection sensors are formed on the upper surface of the array plate.

The plurality of pads may include a first pad and a second pad, and the first pad and the second pad may be alternately and repeatedly disposed.

The first pad and the second pad may have upper surfaces with the same height and have different colors.

The first pad may have black color and the second pad may have white color.

Light generated from the plurality of cliff detection sensors toward the first pad may be absorbed by the first pad, and light generated from the plurality of cliff detection sensors toward the second pad may be reflected by the second pad.

The first pad may be provided in one, the second pad may be provide in two, and the first pad may have a larger width than the second pad.

The first pad may be provided in one, the second pad may be provide in two, and the first pad may have a smaller width than the second pad.

The first pad may be provided in two, the second pad may be provided in three, and the two first pads may have the same width.

The second pad disposed at a center of the array plate among the three second pads may have a smaller width than the first pad, and the second pads at both edges of the array plate among the three second pads may each have a smaller width than the first pad.

The three second pads may each have a smaller width than the first pad.

The first pad may be provided in three, the second pad may be provided in two, and the two second pads may have the same width.

A first pad disposed at a center of the array plate among the three first pads may have a smaller width than the second pad, and first pads disposed at both edges of the array plate among the three first pads may each have a smaller width than the second pad.

The three first pads may each have a smaller width than the second pad.

The plurality of cliff detection sensors may include a plurality of first cliff detection sensors for detecting an obstacle in front, and in a state in which center lines of center lines of the robot cleaner and the main body are aligned, the plurality of first cliff detection sensors may be arranged only on one type of pad among the first pad and the second pad.

In a state in which the center lines of the robot cleaner and the main body are aligned, some of the plurality of first cliff detection sensors may be arranged on the first pad, and the others of the plurality of first cliff detection sensors may be arranged on the second pad.

The plurality of cliff detection sensors may include a plurality of second cliff detection sensors for detecting an obstacle behind, and in a state in which the center lines of the robot cleaner and the main body are aligned, the plurality of second cliff detection sensors and the plurality of first cliff detection sensors may be arranged together on one type of pad among the first pad and the second pad.

According to exemplary embodiments of the present disclosure, a robot cleaner charging device includes a main body defining an outer appearance and provided to charge a robot cleaner including a plurality of cliff detection sensors, and an array plate defining a lower part of the main body and having an upper surface on which a charging terminal for charging the robot cleaner is provided, wherein a plurality of pads provided to allow the robot cleaner to receive different signals through the plurality of cliff detection sensors are formed on the upper surface of the array plate, and the plurality of pads may have the same color and have upper surfaces with different heights.

The plurality of pads may include a first pad and a second pad having an upper surface having a lower height than an upper surface of the first pad, and the first pad and the second pad may be alternately and repeatedly disposed.

According to exemplary embodiments of the present disclosure, a control method of a robot cleaner includes a first operation in which a robot cleaner including a cliff detection sensor approaches the robot cleaner charging device including a charging terminal for charging the robot cleaner and different types of pads through an IR signal, a second operation of checking whether a distance between the robot cleaner and the robot cleaner charging device is less than a first distance, a third operation of checking whether the robot cleaner receives a proximity docking signal generated from the robot cleaner charging device, a fourth operation of checking whether center lines of the robot cleaner and the robot cleaner charging device are aligned through the cliff detection sensor and aligning the center lines, a fifth operation in which the robot cleaner moves straight toward the robot cleaner charging device when the center lines of the robot cleaner and the robot cleaner charging device are aligned, a sixth operation in which the robot cleaner approaches the robot cleaner charging device after the center lines are aligned, a seventh operation of checking the distance between the robot cleaner and the robot cleaner charging device is less than a second distance smaller than the first distance, an eighth operation of checking whether the robot cleaner recognizes the pads through the cliff detection sensor, a ninth operation of checking whether a difference in direction angle occurs between the robot cleaner and the robot cleaner charging device through the cliff detection sensor and correcting the difference in direction angle, and a tenth operation in which the robot cleaner and the charging terminal come into contact when the direction angles of the robot cleaner and the robot cleaner charging device are corrected.

The pads may include a first pad and a second pad that are alternately and repeatedly disposed, the first pad and the second pad may have different colors or have upper surfaces with different heights, the fourth operation may be performed by allowing the robot cleaner to detect a position of each of the first pad and the second pad through the cliff detection sensor and to move to a left or right side, and the ninth operation may be performed by allowing the robot cleaner to detect a position of each of the first pad and the second pad through the cliff detection sensor and to rotate in a clockwise or counterclockwise direction.

### Advantageous Effects

A robot cleaner charging device according to exemplary embodiments of the present disclosure may include an array plate configuring a lower part of a main body and having a charging terminal for charging a robot cleaner, and here, a plurality of pads having different colors or upper surfaces with different heights may be formed on an upper surface of the array plate.

The robot cleaner may include a plurality of cliff detection sensors provided to detect obstacles such as walls, furniture, and cliffs on a traveling surface, and the robot cleaner may receive different signals through the plurality of cliff detection sensors according to pattern shapes of the plurality of pads formed on the array plate in a state in proximity to the robot cleaner charging device.

Accordingly, a center line of the robot cleaner may be aligned with a center line of the robot cleaner charging device, a difference in direction angle between the robot cleaner and the robot cleaner charging device may be corrected thereafter, and docking for charging may be performed more precisely in a state in which the robot cleaner and the robot cleaner charging device are in close proximity.

### DESCRIPTION OF DRAWINGS

FIGS. 1 and 2 are diagrams for explaining a robot cleaner according to an embodiment of the present disclosure.

FIGS. 3 and 4 are diagrams for explaining a robot cleaner charging device according to an embodiment of the present disclosure.

FIG. 5 is a diagram for explaining a difference in signal values received by a cliff detection sensor by two different types of pads according to an embodiment of the present disclosure.

FIGS. 6 to 23 are diagrams for explaining a control method of a robot cleaner using a robot cleaner charging device according to exemplary embodiments of the present disclosure.

FIG. 24 is a flowchart for explaining a method of aligning center lines using a robot cleaner charging device according to an embodiment of the present disclosure.

FIG. 25 is a flowchart for explaining a method of correcting a direction angle using a robot cleaner charging device according to an embodiment of the present disclosure.

### BEST MODE

Hereinafter, specific embodiments of the present disclosure will be described with reference to the drawings. The following detailed description is provided to provide a comprehensive understanding of the methods, apparatus, and/or systems described herein. However, this is merely an example and the present disclosure is not limited thereto.

In the following description of the present disclosure, a detailed description of known technology incorporated herein will be omitted when it may make the subject matter of the present disclosure unclear. The terms used in the specification are defined in consideration of functions used in the present disclosure, and may be changed according to the intent or conventionally used methods of clients, operators, and users. Accordingly, definitions of the terms should be understood on the basis of the entire description of the present specification. The terminology used herein is for the purpose of describing particular embodiments only and is not intended to be limiting of the present disclosure. As used herein, unless explicitly used otherwise, expressions in the singular include the meaning of the plural. In this description, expressions such as “comprising” or “including” are intended to indicate certain features, numbers, steps, operations, elements, some or a combination thereof, and but do not preclude the presence or addition of one or more other features, numbers, steps, operations, elements, some or a combination thereof.

It will be understood that, although the terms first, second, A, B, (a), (b), etc. may be used herein to describe various elements of the present disclosure, these terms are only used to distinguish one element from another element and essential, order, or sequence of corresponding elements are not limited by these terms.

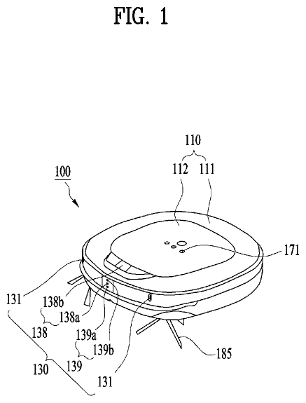

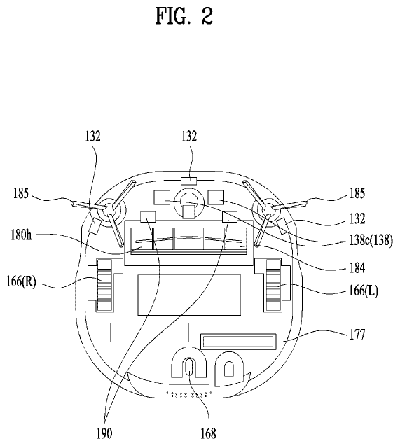

FIGS. 1 and 2 are diagrams for explaining a robot cleaner according to an embodiment of the present disclosure. In more detail, FIG. 1 is a perspective view for explaining an overall appearance of the robot cleaner. FIG. 2 is a bottom view for explaining a lower structure of a robot cleaner.

Referring to FIGS. 1 and 2, a robot cleaner 100 may include a main body 110. Hereinafter, in defining each part of the main body 110, a part facing a ceiling in a traveling area is defined as an upper surface part, a part facing the floor in the traveling area is defined as a bottom surface part, and a part facing a traveling direction of parts constituting a circumference of the main body 110 between the upper surface part and the lower surface part is defined as a front part. In addition, a part facing an opposite direction from the front surface part of the main body 110 is defined as a rear surface part. The main body 110 may include a case 111 defining a space in which various parts constituting the robot cleaner 100 are accommodated.

The robot cleaner 100 may include a sensing part 130 that performs detection to obtain the current state information. The sensing part 130 may detect a surrounding situation of the robot cleaner 100 while the robot cleaner 100 travels, and the sensing part 130 may also detect a state of the robot cleaner 100.

The sensing part 130 may detect information about a traveling zone. The sensing part 130 may detect obstacles such as walls, furniture, and cliffs on the driving surface. The sensing part 130 may detect a robot cleaner charging device 200 to be described later. The sensing part 130 may detect information about the ceiling. Through information detected by the sensing part 130, the robot cleaner 100 may map a traveling zone.

The sensing part 130 may include at least one of a distance detection sensor 131, a cliff detection sensor 132, an external signal detection sensor (not shown), a shock detection sensor (not shown), an image detection sensor 138, 3D sensors 138a, 139a, and 139b, or a docking detection sensor.

The sensing part 130 may include the distance detection sensor 131 for detecting a distance to a surrounding object. The distance detection sensor 131 may be disposed on a front part of the body 110 or may be disposed on a side part. The distance detection sensor 131 may detect surrounding obstacles. The distance detection sensor 131 may be provided in plurality.

For example, the distance detection sensor 131 may be an infrared sensor having a light emitter and a light receiver, an ultrasonic sensor, an RF sensor, a geomagnetic sensor, and the like. The distance detection sensor 131 may be implemented using ultrasonic waves or infrared rays. The distance detection sensor 131 may be implemented using a camera. The distance detection sensor 131 may be implemented with two or more types of sensors.

The sensing part 130 may include a cliff detection sensor 132 that detects obstacles on the floor within the traveling area. The cliff detection sensor 132 may detect whether a cliff exists on the floor.

The cliff detection sensor 132 may be disposed on the bottom surface part of the robot cleaner 100.

The cliff detection sensor 132 may be provided in plurality.

Although FIG. 2 shows that three the cliff detection sensors 132 are provided in front of the bottom surface part of the robot cleaner 100, the concept of the present disclosure is not necessarily limited thereto. That is, the cliff detection sensor 132 may be provided behind the bottom surface part of the robot cleaner 100, and the number of the cliff detection sensors 132 may also not be limited.

The cliff detection sensor 132 may be an infrared ray sensor, an ultrasonic sensor, an RF sensor, a Position Sensitive Detector (PSD), or the like, which includes a light emitter and a light receiver. For example, the cliff detection sensor may be a PSD sensor, but may also include a plurality of different types of sensors. The PSD sensor may include a light emitter that emits infrared rays on obstacles and a light receiver that receives infrared rays reflected from obstacles.

The sensing part 130 may include the shock detection sensor for detecting an impact caused by the robot cleaner 100 coming into contact with an external object.

The sensing part 130 may include the external signal detection sensor for detecting a signal emitted from the outside of the robot cleaner 100. The external signal detection sensor may include at least one of an infrared ray sensor for detecting an infrared ray signal from the outside, an ultrasonic sensor for detecting an ultrasonic wave signal from the outside, or a Radio Frequency (RF) Sensor for detecting an RF signal from the outside.

The sensing part 130 may include the image detection sensor 138 for detecting an image of the outside of the robot cleaner 100.

The image detection sensor 138 may include a digital camera. The digital camera may include an image sensor (e.g., CMOS image sensor) including at least one optical lens and a plurality of photodiodes (e.g., pixels) forming an image by light passing through the optical lens, and a digital signal processor (DSP) configuring an image based on signals output from the photodiodes. The DSP may generate not only a still image, but also a moving image including frames configured with still images.

The image detection sensor 138 may include a front image sensor 138a for detecting a forward image of the robot cleaner 100. The front image sensor 138a may detect an image of a nearby object, such as an obstacle or the robot cleaner charging device 200.

The image detection sensor 138 may include an upward image sensor 138b for detecting an upward image of the robot cleaner 100. The upper image sensor 138b may detect an image of a ceiling or a lower surface of furniture disposed above the robot cleaner 100.

The image detection sensor 138 may include a downward image sensor 138c for detecting a downward image of the robot cleaner 100. The downward image sensor 138c may detect an image of the floor.

The image detection sensor 138 may include a sensor for detecting images from the side or the rear.

The sensing part 130 may include the 3D sensors 138a, 139a, and 139b that detect 3D information of an external environment.

The 3D sensors 138a, 139a, and 139b may include a 3D depth camera 138a that calculates a near distance of the robot cleaner 100 and an object to be photographed.

In the present embodiment, the 3D sensors 138a, 139a, and 139b may include a pattern emitter 139 that emits a predetermined pattern of light toward the body 110, and the front image sensor 138a that acquires an image of the front of the body 110. The pattern emitter 139 may include a first pattern emitter 139a for emitting light of a first pattern toward a lower side of the front of the body 110, and a second pattern emitter 139b for emitting light of a second pattern toward an upper side of the front of the body 110. The front image sensor 138a may acquire an image of an area where the light of the first pattern and the light of the second pattern are incident.

The pattern emitter 139 may be provided to emit an infrared ray pattern.

In this case, the front image sensor 138a may measure a distance between the 3D sensor and the object to be photographed by capturing a shape of the infrared ray pattern projected onto the object to be photographed.

The light of the first pattern and the light of the second pattern may be emitted in the form of straight lines intersecting each other. The light of the first pattern and the light of the second pattern may be emitted in the form of horizontal straight lines spaced vertically.

The sensing part 130 may include a docking detection sensor (not shown) that detects whether or not docking of the robot cleaner 100 is successful with respect to the robot cleaner charging device 200. The docking detection sensor may be implemented to be detected by contact between the corresponding terminal 190 and the charging terminal 215 or may be implemented as a detection sensor disposed separately from the corresponding terminal 190, and may be implemented by detecting the charging state of the battery 177 during charging. A docking success state and a docking failure state may be detected by the docking detection sensor.

The robot cleaner 100 may include the battery 177 for supplying driving power to each component. The battery 177 may supply power for the robot cleaner 100 to perform an action according to selected action information. The battery 177 may be mounted on the body 110. The battery 177 may be detachably provided in the body 110.

The battery 177 may be provided to be charged as the robot cleaner 100 is docked with the robot cleaner charging device 200 and the charging terminal 215 and the corresponding terminal 190 are connected. When the charge amount of the battery 177 is equal to or less than a predetermined value, the robot cleaner 100 may start a docking mode for charging. In the docking mode, the robot cleaner 100 may return to the robot cleaner charging device 200.

The robot cleaner 100 may include a traveling part that moves the body 110 with respect to the floor. The traveling part may include at least one driving wheel 166 for moving the body 110 and a driving motor (not shown) for driving the same. The driving wheel 166 may include a left wheel 166 (L) and a right wheel 166 (R) provided on the left and right sides of the body 110, respectively.

The left wheel 166 (L) and the right wheel 166 (R) may be driven by one drive motor, but if necessary, a left wheel drive motor for driving the left wheel 166 (L) and a right wheel driving motor for the right wheel 166 (R) may be provided, respectively. A traveling direction of the body 110 may be switched to the left or right by making a difference between rotation speeds of the left wheel 166 (L) and the right wheel 166 (R).

The traveling part may further include an auxiliary wheel 168 that does not provide a separate driving force but assists the main body with respect to the floor.

The robot cleaner 100 may include a work part that performs a predetermined task. The robot cleaner 100 may move the traveling zone and may clean the floor by the work part. The work part may perform suction of foreign substances and may perform wiping.

The work part may include a suction device for sucking foreign substances, brushes 184 and 185 for sweeping, a dust bin (not shown) for storing foreign substances collected by the suction device or the brush, and/or a mop part (not shown) for performing wiping.

A suction port 180h through which air is sucked may be formed on the bottom surface part of the body 110. A suction device (not shown) that provides suction power for sucking air through the suction port 180h and a dust bin (not shown) for collecting dust sucked together with air through the suction port 180h may be provided inside the body 110.

An opening for insertion and removal of the dust bin may be formed in the case 111, and a dust bin cover 112 that opens and closes the opening may be rotatably provided with respect to the case 111.

The work part may include a roll-type main brush 184 having brushes exposed through the suction port 180h, and an auxiliary brush 185 having a plurality of radially extending wings located on the front side of the bottom surface part of the body 110. Dust may be removed from the floor in the traveling area by rotation of these brushes 184 and 185, and dust separated from the floor may be sucked through the suction port 180h and collected in the dust bin.

The robot cleaner 100 may include the corresponding terminal 190 for charging the battery 177 when docked with the robot cleaner charging device 200. The corresponding terminal 190 may be disposed at a position accessible to the charging terminal 215 of the robot cleaner charging device 200 in a successful docking state of the robot cleaner 100. In one embodiment, a pair of the corresponding terminals 190 may be disposed on the bottom surface part of the body 110.

The robot cleaner 100 may include an input interface 171 for inputting information. The input interface 171 may receive On/Off or various commands. The input interface 171 may include a button, a key, a touch type display, or the like. The input interface 171 may include a microphone for voice recognition.

The robot cleaner 100 may include an output interface (not shown) for outputting information, a communication interface (not shown) for transmitting and receiving information with other external devices, and a storage (not shown) for storing various information.

The robot cleaner 100 may include a controller (not shown) that processes and determines various information such as mapping and/or recognizing the current location therein, and the controller may control the overall operation of the robot cleaner 100 through control of various components of the robot cleaner 100.

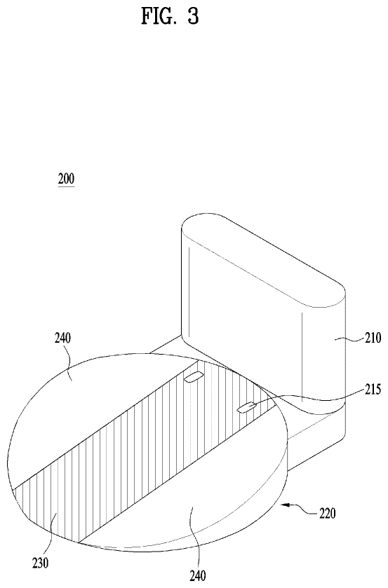

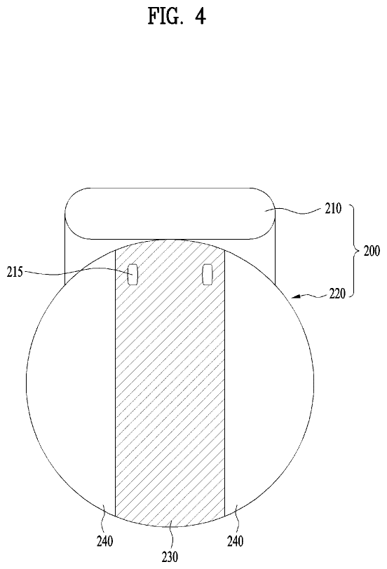

FIGS. 3 and 4 are diagrams for explaining a robot cleaner charging device according to an embodiment of the present disclosure. In more detail, FIG. 3 is a perspective view for explaining the overall appearance of the robot cleaner charging device, and FIG. 4 is a plan view of the robot cleaner charging device viewed from the top.

Referring to FIGS. 3 and 4, the robot cleaner charging device 200 may be provided to be placed on the floor, and may include the charging terminal 215 provided to be connected to the corresponding terminal 190 in a successful docking state of the robot cleaner 100.

In detail, the robot cleaner charging device 200 may include a main body 210 that defines an outer appearance and provided to charge a robot cleaner including a plurality of cliff detection sensors, and an array plate 220 that configures a lower side of the main body 210 and on which the charging terminal 215 for charging the robot cleaner 100 is provided. In this case, a plurality of pads 230 and 240 may be formed on an upper surface of the array plate 220 to allow the robot cleaner 100 to receive different signals through a plurality of cliff detection sensors 132.

The plurality of pads 230 and 240 may include a first pad 230 and a second pad 240 having different colors or upper surfaces with different heights. The first pad 230 and the second pad 240 may be alternately and repeatedly disposed.

In exemplary embodiments, the first pad 230 and the second pad 240 may have upper surfaces with the same height, but may be formed of different colors. In one embodiment, the first pad 230 may be made of black color, for example, and the second pad 240 may be made of white color, for example. In another embodiment, the first pad 230 may be made of white color, for example, and the second pad 240 may be made of black color, for example. The colors of the first pad 230 and the second pad 240 may be other than black or white.

Alternatively, the first pad 230 and the second pad 240 may be made of the same color but have upper surfaces of different heights. In this case, the heights of the upper surfaces of the first pad 230 and the second pad 240 may not be particularly limited.

The main body 210 of the robot cleaner charging device 200 may be made of various materials as needed. In exemplary embodiments, the main body 210 may be made of an opaque material that may be visually blocked from the outside, or may be made of a transparent or translucent material that is visually exposed from the outside.

Various components for charging the robot cleaner 100, for example, a printed circuit board, a sensor, a guide member, etc. may be provided inside the main body 210 of the robot cleaner charging device 200, and a docking confirmation part (not shown) for checking whether the robot cleaner 100 is docked may be further provided.

The array plate 220 of the robot cleaner charging device 200 may have a flat upper surface and may be inclined at a predetermined angle with respect to the ground. In exemplary embodiments, a portion of the array plate 220 adjacent to the main body 210 may have an upper surface higher than a lower surface of the main body 210, and the upper surface of the array plate 220 may be formed to have a constant angle from an adjacent portion to the main body 210 to a portion spaced apart from the main body 210. In one embodiment, a portion of the array plate 220 spaced apart from the main body 210 may partially have the same height as a lower surface of the main body 210.

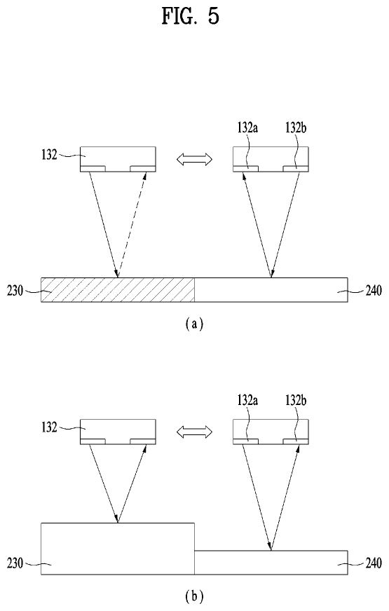

FIG. 5 is a diagram for explaining a difference in signal values received by a cliff detection sensor by two different types of pads according to an embodiment of the present disclosure.

Referring to FIG. 5(a), the plurality of cliff detection sensors 132 included in the robot cleaner 100 may include a light transmitter 132a for transmitting light and a light receiver 132b for receiving light, respectively. In addition, the first pad 230 may be made of black color, and the second pad 240 may be made of white color.

In this case, light generated toward the first pad 230 from the light transmitter 132a may be absorbed by the first pad 230 and may not be received by the light receiver 132b, and light generated toward the second pad 240 from the light transmitter 132a may be reflected by the second pad 240 and may be received by the light receiver 132b.

Thus, when a signal value when a signal is not received by the light receiver 132b is 0 and a signal value when a signal is received by the light receiver 132b is 1, a signal value received when the cliff detection sensor 132 moves on the first pad 230 may be 0, and a signal value received when the cliff detection sensor 132 moves on the second pad 240 may be 1. Accordingly, the robot cleaner 100 may induce a docking operation for charging according to pattern shapes of the first pad 230 and the second pad 240.

As shown in FIG. 5(b), the first pad 230 and the second pad 240 may have upper surfaces of different heights. In exemplary embodiments, the first pad 230 may have a relatively high upper surface, and the second pad 240 may have a relatively low upper surface. In this case, the first pad 230 and the second pad 240 may be made of the same color, for example, white.

In this case, since the cliff detection sensor 132 may have different signals according to a distance at which light is transmitted and received, the reflected light generated from the light transmitter 132a toward the first pad 230 and the reflected light generated from the light transmitter 132a toward the second pad 240 may have different signal values.

Therefore, when a signal value of the cliff detection sensor 132 that detects a relatively short distance is 0 and a signal value of the cliff detection sensor 132 that detects a relatively long distance is 1, a signal value received when the cliff detection sensor 132 moves on the first pad 230 may be 0, and a signal value received when the cliff detection sensor 132 moves on the second pad 240 may be 1. Accordingly, the robot cleaner 100 may induce a docking operation for charging according to pattern shapes of the first pad 230 and the second pad 240.

Hereinafter, for convenience of explanation, a control method of the robot cleaner 100 using the robot cleaner charging device 200 in which the first pad 230 is made of black color, the second pad 240 is made of white color, and the first pad 230 and the second pad 240 have upper surfaces with the same height will be described, but the concept of the present disclosure is not necessarily limited thereto. That is, a control method of the robot cleaner 100 using the robot cleaner charging device 200 in which the first pad 230 has a relatively high upper surface, the second pad 240 has a relatively low upper surface, and the first pad 230 and the second pad 240 have the same color may be performed through a similar operating principle to the above.

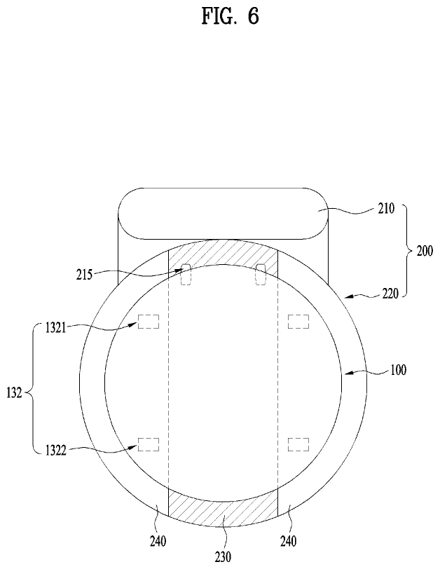

FIGS. 6 to 23 are diagrams for explaining a control method of a robot cleaner using a robot cleaner charging device according to exemplary embodiments of the present disclosure.

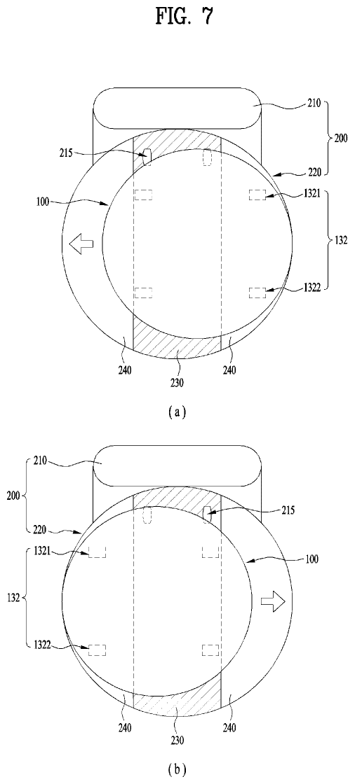

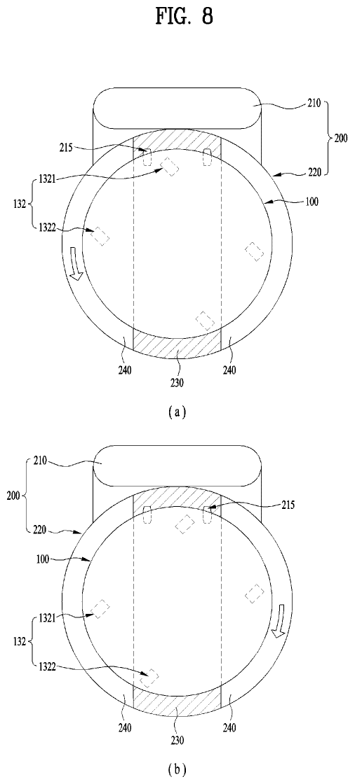

FIG. 6 is a plan view for explaining a state in which the robot cleaner 100 is arranged in a correct position on the robot cleaner charging device 200, and FIG. 7 is a plan view showing a state in which a center line of the robot cleaner 100 and a center line of the robot cleaner charging device 200 are not aligned. FIG. 8 is a plan view for explaining a non-aligned state, and FIG. 8 is a plan view for explaining a state in which a difference in direction angle occurs between the robot cleaner 100 and the robot cleaner charging device 200.

Referring to FIGS. 6 to 8, the cliff detection sensor 132 of the robot cleaner 100 may include two first cliff detection sensors 1321 for detecting obstacles in front of the bottom surface part, and two second cliff detection sensors 1322 for detecting obstacles behind the bottom surface part, and the array plate 220 of the robot cleaner charging device 200 may include one first pad 230 formed to cross the center of the array plate 220 and two second pads 240 formed to cover both sidewalls of the first pad 230. In this case, the first pad 230 may have a smaller width than the second pad 240.

In this case, the robot cleaner 100 may determine a state in which all signal values received by the cliff detection sensors 132 are ‘1’ as a state in which a central line of the robot cleaner 100 and the center line of the robot cleaner charging device 200 are aligned.

In detail, as shown in FIG. 6, the robot cleaner 100 may determine a state in which both the first cliff detection sensor 1321 and the second cliff detection sensor 1322 are positioned only on the second pad 240, but not on the first pad 230 as the state in which the center line of the robot cleaner 100 and the center line of the robot cleaner charging device 200 are aligned.

The robot cleaner 100 may determine a state in which at least one of signal values received by the cliff detection sensors 132 is ‘0’ as a state in which the center line of the robot cleaner 100 and the center line of the robot cleaner charging device 200 are not aligned or a difference in direction angle occurs between the robot cleaner 100 and the robot cleaner charging device 200.

In detail, the robot cleaner 100 may determine a state in which some of the first cliff detection sensors 1321 and the second cliff detection sensors 1322 are located on the second pad 240 and the others are located on the first pad 230 as a state in which the center of the robot cleaner 100 and the center line of the robot cleaner charging device 200 are not aligned, or a difference in direction angle occurs between the robot cleaner 100 and the robot cleaner charging device 200.

For example, as shown in FIG. 7(a), the robot cleaner 100 may determine a state in which the first cliff detection sensor 1321 and the second cliff detection sensor 1322 that are each provided on the left side are located on the first pad 230 and the first cliff detection sensor 1321 and the second cliff detection sensor 1322 that are each provided on the right side are located on the second pad 240 as a state in which the robot cleaner 100 is arranged on the right side on the array plate 220 of the robot cleaner charging device 200.

In this case, the robot cleaner 100 may be controlled to move to the left, and accordingly, the center line of the robot cleaner 100 and the center line of the robot cleaner charging device 200 may be aligned.

For example, as shown in FIG. 7(b), the robot cleaner 100 may determine a state in which the first cliff detection sensor 1321 and the second cliff detection sensor 1322 that are each provided on the right side are located on the first pad 230 and the first cliff detection sensor 1321 and the second cliff detection sensor 1322 that are each provided on the left side are allocated on the second pad 240 as a state in which the robot cleaner 100 is arranged on the left side of the array plate 220 of the robot cleaner charging device 200.

In this case, the robot cleaner 100 may be controlled to move to the right, and accordingly, the center line of the robot cleaner 100 and the center line of the robot cleaner charging device 200 may be aligned.

For example, as shown in FIG. 8(a), the robot cleaner 100 may determine a state in which the first cliff detection sensor 1321 provided on the left front and the second cliff detection sensor 1322 provided on the right rear are located on the first pad 230, and the first cliff detection sensor 1322 provided on the left rear and the second cliff detection sensor 1322 provided on the right front are located on the second pad 240 as a state in which a difference in direction angle in a clockwise direction occurs between the robot cleaner 100 and the robot cleaner charging device 200.

In this case, the robot cleaner 100 may be controlled to rotate in a counterclockwise direction, and thus a difference in direction angle between the robot cleaner 100 and the robot cleaner charging device 200 may be corrected.

For example, as shown in FIG. 8(b), the robot cleaner 100 may determine a state in which the first cliff detection sensor 1321 provided on the right front and the second cliff detection sensor 1322 provided on the left rear are located on the first pad 230, and the first cliff detection sensor 1321 provided on the left front and the second cliff detection sensor 1322 provided on the right rear are located on the second pad 240 as a state in which a difference in direction angle in a counterclockwise direction occurs between the robot cleaner 100 and the robot cleaner charging device 200.

In this case, the robot cleaner 100 may be controlled to rotate in a clockwise direction, and thus a difference in direction angle between the robot cleaner 100 and the robot cleaner charging device 200 may be corrected.

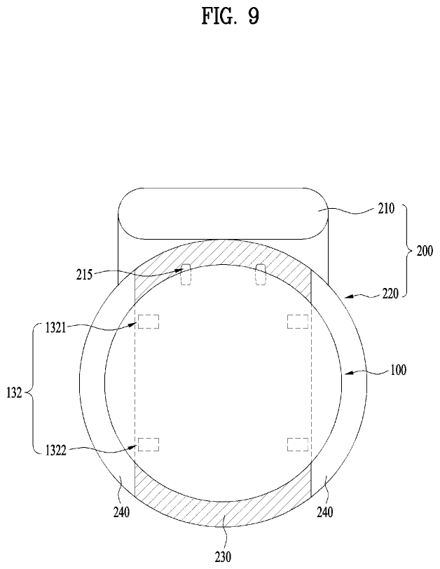

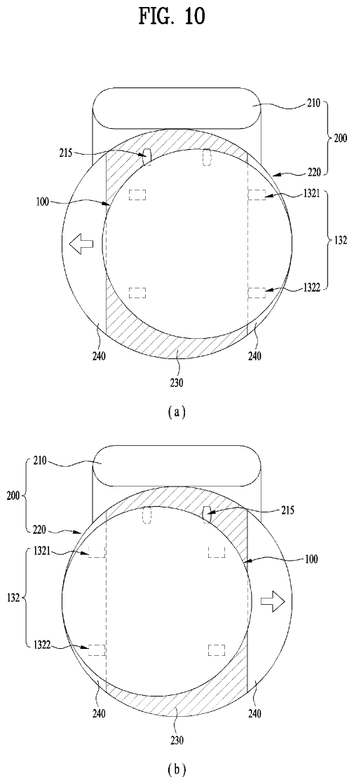

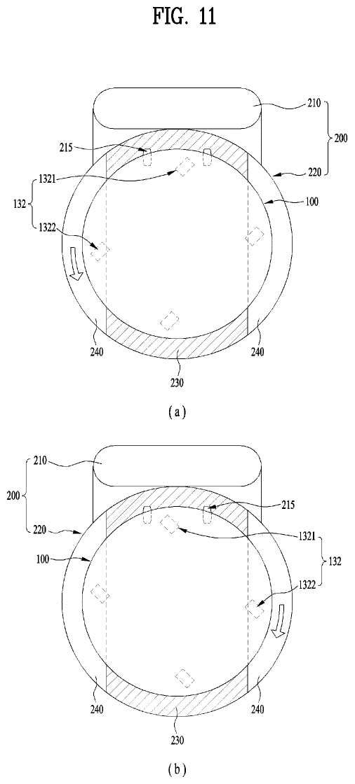

FIG. 9 is a plan view for explaining a state in which the robot cleaner 100 is arranged at a correct position on the robot cleaner charging device 200, FIG. 10 is a plan view for explaining a state in which the center line of the robot cleaner 100 and the center line of the robot cleaner charging device 200 11 are not aligned, and FIG. 11 is a plan view for explaining a state in which a difference in direction angle occurs between the robot cleaner 100 and the robot cleaner charging device 200.

The robot cleaner 100 shown in FIGS. 9 to 11 is substantially the same as the robot cleaner 100 shown in FIGS. 6 to 8, and the robot cleaner charging device 200 shown in FIGS. 9 to 11 is similar to the robot cleaner charging device 200 shown in FIGS. 6 to 8 except for patterns shapes of the first pad 230 and the second pad 240. Accordingly, a detailed description of the same content among the contents of the robot cleaner 100 and the robot cleaner charging device 200 will be omitted.

Referring to FIGS. 9 to 11, the array plate 220 of the robot cleaner charging device 200 may include one first pad 230 formed to cross the center of the array plate 220 and two second pads 240 formed to cover both sidewalls of the first pad 230. In this case, the first pad 230 may have a larger width than the second pad 240.

In this case, the robot cleaner 100 may determine a state in which all signal values received by the cliff detection sensors 132 are ‘0’ as a state in which a central line of the robot cleaner 100 and the center line of the robot cleaner charging device 200 are aligned.

In detail, as shown in FIG. 9, the robot cleaner 100 may determine a state in which both the first cliff detection sensor 1321 and the second cliff detection sensor 1322 are positioned only on the first pad 230, but not on the second pad 240 as a state in which the center line of the robot cleaner 100 and the center line of the robot cleaner charging device 200 are aligned.

The robot cleaner 100 may determine a state in which at least one of signal values received by the cliff detection sensors 132 is ‘1’ as a state in which the center line of the robot cleaner 100 and the center line of the robot cleaner charging device 200 are not aligned or a difference in direction angle occurs between the robot cleaner 100 and the robot cleaner charging device 200.

In detail, the robot cleaner 100 may determine a state in which some of the first cliff detection sensors 1321 and the second cliff detection sensors 1322 are located on the second pad 240 and the others are located on the first pad 230 as a state in which the center line of the robot cleaner 100 and the center line of the robot cleaner charging device 200 are not aligned or a difference in direction angle occurs between the robot cleaner 100 and the robot cleaner charging device 200.

For example, as shown in FIG. 10(a), the robot cleaner 100 may determine a state in which the first cliff detection sensor 1321 and the second cliff detection sensor 1322 that are each provided on the left side are located on the first pad 230 and the first cliff detection sensor 1321 and the second cliff detection sensor 1322 that are each provided on the right side are located on the second pad 240 as a state in which the robot cleaner 100 is arranged on the right side on the array plate 220 of the robot cleaner charging device 200.

In this case, the robot cleaner 100 may be controlled to move to the left, and accordingly, the center line of the robot cleaner 100 and the center line of the robot cleaner charging device 200 may be aligned.

For example, as shown in FIG. 10(b), the robot cleaner 100 may determine a state in which the first cliff detection sensor 1321 and the second cliff detection sensor 1322 that are each provided on the right side are located on the first pad 230 and the first cliff detection sensor 1321 and the second cliff detection sensor 1322 that are each provided on the left side are allocated on the second pad 240 as a state in which the robot cleaner 100 is arranged on the left side of the array plate 220 of the robot cleaner charging device 200.

In this case, the robot cleaner 100 may be controlled to move to the right, and accordingly, the center line of the robot cleaner 100 and the center line of the robot cleaner charging device 200 may be aligned.

For example, as shown in FIG. 11(a), the robot cleaner 100 may determine a state in which the first cliff detection sensor 1321 provided on the left front and the second cliff detection sensor 1322 provided on the right rear are located on the first pad 230, and the first cliff detection sensor 1321 provided on the left rear and the second cliff detection sensor 1322 provided on the right front are located on the second pad 240 as a state in which a difference in direction angle in a clockwise direction occurs between the robot cleaner 100 and the robot cleaner charging device 200.

In this case, the robot cleaner 100 may be controlled to rotate in a counterclockwise direction, and thus a difference in direction angle between the robot cleaner 100 and the robot cleaner charging device 200 may be corrected.

For example, as shown in FIG. 11(b), the robot cleaner 100 may determine a state in which the first cliff detection sensor 1321 provided on the right front and the second cliff detection sensor 1322 provided on the left rear are located on the first pad 230, and the first cliff detection sensor 1321 provided on the left front and the second cliff detection sensor 1322 provided on the right rear are located on the second pad 240 as a state in which a difference in direction angle in a counterclockwise direction occurs between the robot cleaner 100 and the robot cleaner charging device 200.

In this case, the robot cleaner 100 may be controlled to rotate in a clockwise direction, and thus a difference in direction angle between the robot cleaner 100 and the robot cleaner charging device 200 may be corrected.

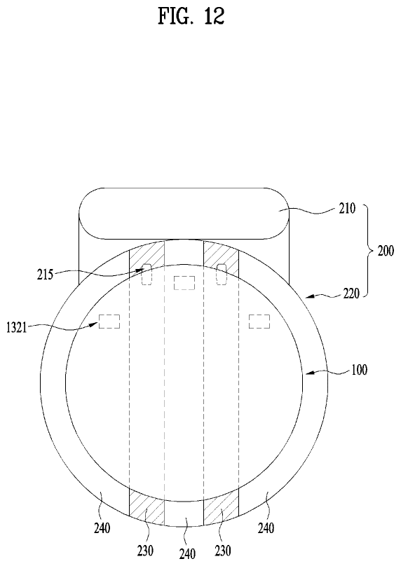

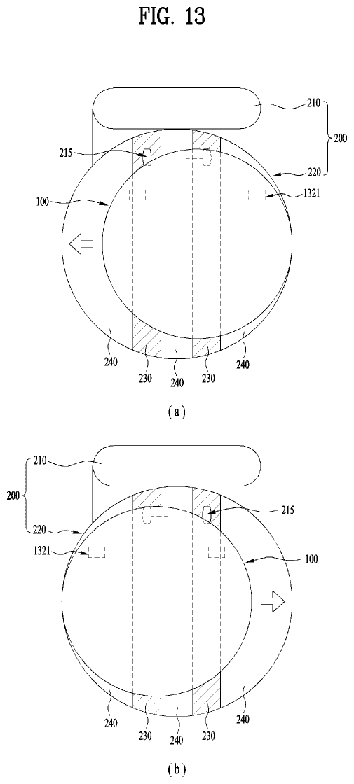

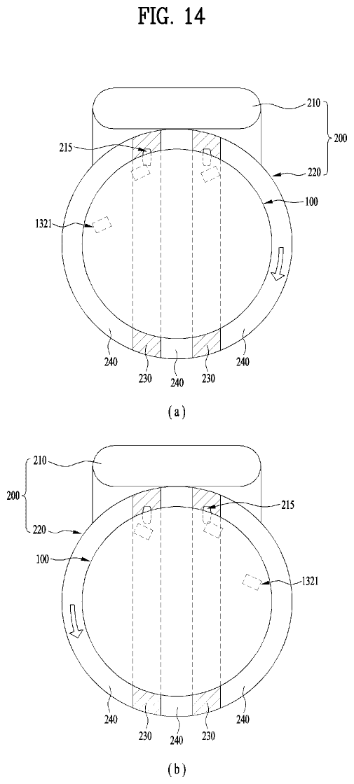

FIG. 12 is a plan view for explaining a state in which the robot cleaner 100 is arranged at a correct position on the robot cleaner charging device 200, FIG. 13 is a plan view for explaining a state in which the center line of the robot cleaner 100 and the center line of the robot cleaner charging device 200 11 are not aligned, and FIG. 14 is a plan view for explaining a state in which a difference in direction angle occurs between the robot cleaner 100 and the robot cleaner charging device 200.

The robot cleaner 100 shown in FIGS. 12 to 14 is similar to the robot cleaner 100 shown in FIGS. 6 to 8 except that the number of each of the first cliff detection sensors 1321 and the second cliff detection sensors 1322 is different, and the robot cleaner charging device 200 shown in FIGS. 12 to 14 is similar to the robot cleaner charging device 200 shown in FIGS. 6 to 8 except for pattern shapes of the first pad 230 and the second pad 240. Accordingly, a detailed description of the same content among the contents of the robot cleaner 100 and the robot cleaner charging device 200 will be omitted.

Referring to FIGS. 12 to 14, the cliff detection sensor 132 of the robot cleaner 100 may include three first cliff detection sensors 1321 for detecting obstacles in front of the bottom surface part, and the array plate 220 of the robot cleaner charging device 200 may include two first pads 230 formed to cover specific portions of the array plate 220 and three second pads 240 formed to cover both sidewalls of the first pad 230. In this case, the cliff detection sensor 132 of the robot cleaner 100 may not include the second cliff detection sensor 1322 for detecting obstacles behind the bottom surface part, but the concept of the present disclosure is not necessarily limited thereto. That is, the cliff detection sensor 132 of the robot cleaner 100 may further include one or more second cliff detection sensors 1322.

In exemplary embodiments, the second pad 240 formed on the left side of the array plate 220 and the second pad 240 formed on the right side of the array plate 220 may have the same width, and the second pad 240 formed in the center of the array plate 220 may have a smaller width than these. In one embodiment, the two first pads 230 may have the same width, and may have a smaller width of each of the three second pads 240.

In this case, the robot cleaner 100 may determine a state in which all signal values received by the cliff detection sensors 132 are ‘1’ as a state in which a central line of the robot cleaner 100 and the center line of the robot cleaner charging device 200 are aligned.

In detail, as shown in FIG. 12, the robot cleaner 100 may determine a state in which all the first cliff detection sensors 1321 are positioned on the second pad 240, but not on the first pad 230 as a state in which the center line of the robot cleaner 100 and the center line of the robot cleaner charging device 200 are aligned.

FIGS. 13 and 14 show the case in which a portion of one first cliff detection sensor 1321 is located on the first pad 230 and the other portion is located on the second pad 240, and in this case, the portion located on the first pad 230 may receive a signal value of 0 and the other part located on the second pad 240 may receive a signal value of 1, and accordingly, the one first cliff detection sensor 1321 may receive a non-constant signal value of ‘0->1’ or ‘1->0’ as a whole. As such, when the one cliff detection sensor 132 is located on each of the first pad 230 and the second pad 240, the signal value received by the one cliff detection sensor 132 will marked as ‘01’ or ‘10’. In order to avoid a state in which the first cliff detection sensor 1321 partially overlaps the first pad 230 and the second pad 240, the width of each of the first pad 230 and the second pad 240 may be adjusted, and each color of the first pad 230 and the second pad 240 may be changed, or the position or width of each of the first cliff detection sensors 1321 may be adjusted.

In detail, as shown in FIGS. 13 and 14, the robot cleaner 100 may determine a state in which at least one of signals received by the cliff detection sensors 132 is ‘0’, ‘01’, or ‘10’ as a state in which the center line of the robot cleaner 100 and the center line of the robot cleaner charging device 200 are not aligned or a difference in direction angle occurs between the robot cleaner 100 and the robot cleaner charging device 200.

In detail, the robot cleaner 100 may determine a state in which at least one of the three first cliff detection sensors 1321 is located on the first pad 230 as a state in which the center line of the robot cleaner 100 and the center line of the robot cleaner charging device 200 are not aligned or a difference in direction angle occurs between the robot cleaner 100 and the robot cleaner charging device 200.

For example, as shown in FIG. 13(a), the robot cleaner 100 may determine a state in which the first cliff detection sensors 1321 that are provided on the left and center respectively are located on the first pad 230 and the first cliff detection sensor 1321 provided on the right is located on the second pad 240 as a state in which the robot cleaner 100 is arranged on the right side on the array plate 220 of the robot cleaner charging device 200. In this case, signal values received by the first cliff detection sensors 1321 provided on the left and center respectively may each be ‘10’.

In this case, the robot cleaner 100 may be controlled to move to the left, and accordingly, the center line of the robot cleaner 100 and the center line of the robot cleaner charging device 200 may be aligned.

For example, as shown in FIG. 13(b), the robot cleaner 100 may determine a state in which the first cliff detection sensors 1321 that are provided on the right and center respectively are located on the first pad 230 and the first cliff detection sensor 1321 provided on the left is located on the second pad 240 as a state in which the robot cleaner 100 is arranged on the left side of the array plate 220 of the robot cleaner charging device 200. In in this case, signal values received by the first cliff detection sensors 1321 that are provided on the right and center respectively may each be ‘01’.

In this case, the robot cleaner 100 may be controlled to move to the right, and accordingly, the center line of the robot cleaner 100 and the center line of the robot cleaner charging device 200 may be aligned.

For example, as shown in FIG. 14(a), the robot cleaner 100 may determine a state in which the first cliff detection sensors 1321 that are provided on the right and center respectively are located on the first pad 230 and the first cliff detection sensor 1321 provided on the left is located on the second pad 240 as a state in which a difference in direction angle in a counterclockwise direction occurs between the robot cleaner 100 and the robot cleaner charging device 200. In this case, a signal value received by the first cliff detection sensor 1321 provided at the center may be ‘10’.

In this case, the robot cleaner 100 may be controlled to rotate in a clockwise direction, and thus a difference in direction angle between the robot cleaner 100 and the robot cleaner charging device 200 may be corrected.

For example, as shown in FIG. 14(b), the robot cleaner 100 may determine a state in which the first cliff detection sensors 1321 that are provided on the left and center respectively are located on the first pad 230 and the first cliff detection sensor 1321 provided on the right is located on the second pad 240 as a state in which a difference in direction angle in a clockwise direction occurs between the robot cleaner 100 and the robot cleaner charging device 200. In this case, a signal value received by the first cliff detection sensor 1321 provided at the center may be ‘01’.

In this case, the robot cleaner 100 may be controlled to rotate in a counterclockwise direction, and thus a difference in direction angle between the robot cleaner 100 and the robot cleaner charging device 200 may be corrected.

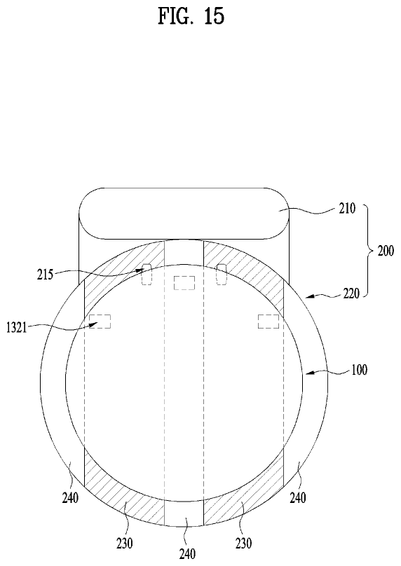

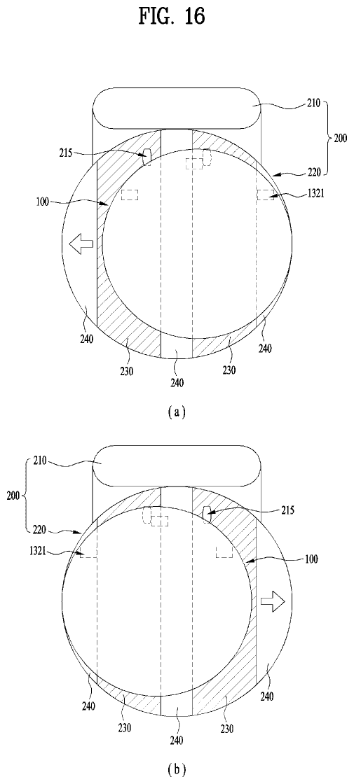

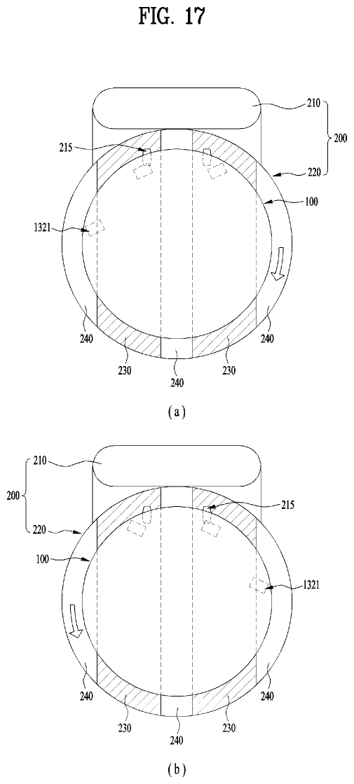

FIG. 15 is a plan view for explaining a state in which the robot cleaner 100 is arranged in a correct position on the robot cleaner charging device 200, FIG. 16 is a plan view showing a state in which the center line of the robot cleaner 100 and the center line of the robot cleaner charging device 200 are not aligned, and FIG. 17 is a plan view for explaining a state in which a difference in direction angle occurs between the robot cleaner 100 and the robot cleaner charging device 200.

The robot cleaner 100 shown in FIGS. 15 to 17 is similar to the robot cleaner 100 shown in FIGS. 6 to 8 except that the number of each of the first cliff detection sensors 1321 and the second cliff detection sensors 1322 is different, and the robot cleaner charging device 200 shown in FIGS. 15 to 17 is similar to the robot cleaner charging device 200 shown in FIGS. 6 to 8 except for pattern shapes of the first pad 230 and the second pad 240. Accordingly, a detailed description of the same content among the contents of the robot cleaner 100 and the robot cleaner charging device 200 will be omitted.

Referring to FIGS. 15 to 17, the cliff detection sensor 132 of the robot cleaner 100 may include three first cliff detection sensors 1321 for detecting obstacles in front of the bottom surface part, and the array plate 220 of the robot cleaner charging device 200 may include two first pads 230 formed to cover specific portions of the array plate 220 and three second pads 240 formed to cover both sidewalls of the first pad 230. In this case, the cliff detection sensor 132 of the robot cleaner 100 may not include the second cliff detection sensor 1322 for detecting obstacles behind the bottom surface part, but the concept of the present disclosure is not necessarily limited thereto. That is, the cliff detection sensor 132 of the robot cleaner 100 may further include one or more second cliff detection sensors 1322.

In exemplary embodiments, the second pad 240 formed on the left side of the array plate 220 and the second pad 240 formed on the right side of the array plate 220 may have the same width, and the second pad 240 formed in the center of the array plate 220 may have a smaller width than these. In one embodiment, the two first pads 230 may have the same width, and may have a larger width of each of the three second pads 240.

In this case, the robot cleaner 100 may determine a state in which only a signal value received by the cliff detection sensor 132 provided at the center is ‘1’ and all signal values received by the cliff detection sensors 132 that are respectively provided on the right and left sides are each ‘0’ as a state in which the center line of the robot cleaner 100 and the center line of the robot cleaner charging device 200 are aligned.

In detail, as shown in FIG. 15, the robot cleaner 100 may determine a state in which the first cliff detection sensor 1321 provided at the center is located on the second pad 240 and both the first cliff detection sensors 1321 that are respectively provided on the right and left sides are located on the first pad 230 as a state in which the center line of the robot cleaner 100 and the center line of the robot cleaner charging device 200 are aligned.

The robot cleaner 100 may determine the following state as a state in which the center line of the robot cleaner 100 and the center line of the robot cleaner charging device 200 are not aligned or a difference in direction angle occurs between the robot cleaner 100 and the robot cleaner charging device 200.

For example, as shown in FIG. 16(a), the robot cleaner 100 may determine a state in which the first cliff detection sensors 1321 that are provided on the left and center respectively are located on the first pad 230 and the first cliff detection sensor 1321 provided on the right is located on the second pad 240 as a state in which the robot cleaner 100 is arranged on the right side on the array plate 220 of the robot cleaner charging device 200. In this case, a signal value received by the first cliff detection sensor 1321 provided at the center may be ‘10’.

In this case, the robot cleaner 100 may be controlled to move to the left, and accordingly, the center line of the robot cleaner 100 and the center line of the robot cleaner charging device 200 may be aligned.

For example, as shown in FIG. 16(b), the robot cleaner 100 may determine a state in which the first cliff detection sensors 1321 that are provided on the right and center respectively are located on the first pad 230 and the first cliff detection sensor 1321 provided on the left is located on the second pad 240 as a state in which the robot cleaner 100 is arranged on the left side on the array plate 220 of the robot cleaner charging device 200. In in this case, a signal value received by the first cliff detection sensor 1321 provided at the center may be ‘01’.

In this case, the robot cleaner 100 may be controlled to move to the right, and accordingly, the center line of the robot cleaner 100 and the center line of the robot cleaner charging device 200 may be aligned.

For example, as shown in FIG. 17(a), the robot cleaner 100 may determine a state in which the first cliff detection sensors 1321 that are provided on the right and center respectively are located on the first pad 230 and the first cliff detection sensor 1321 provided on the left is located on the second pad 240 as a state in which a difference in direction angle in a counterclockwise direction occurs between the robot cleaner 100 and the robot cleaner charging device 200. In this case, a signal value received by the first cliff detection sensor 1321 provided on the left may be ‘10’.

In this case, the robot cleaner 100 may be controlled to rotate in a clockwise direction, and thus a difference in direction angle between the robot cleaner 100 and the robot cleaner charging device 200 may be corrected.

For example, as shown in FIG. 17(b), the robot cleaner 100 may determine a state in which the first cliff detection sensors 1321 that are provided on the left and center respectively are located on the first pad 230 and the first cliff detection sensor 1321 provided on the right is located on the second pad 240 as a state in which a difference in direction angle in a clockwise direction occurs between the robot cleaner 100 and the robot cleaner charging device 200. In this case, a signal value received by the first cliff detection sensor 1321 provided on the right may be ‘01’.

In this case, the robot cleaner 100 may be controlled to rotate in a counterclockwise direction, and thus a difference in direction angle between the robot cleaner 100 and the robot cleaner charging device 200 may be corrected.

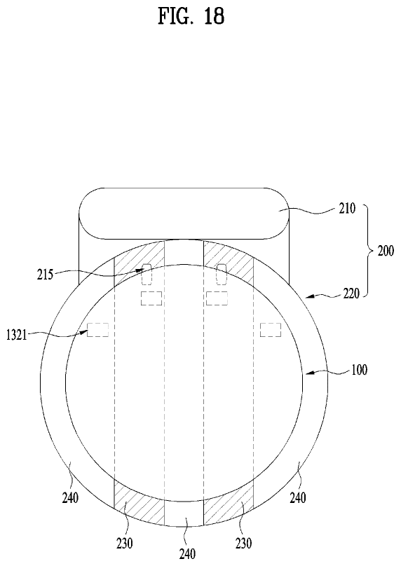

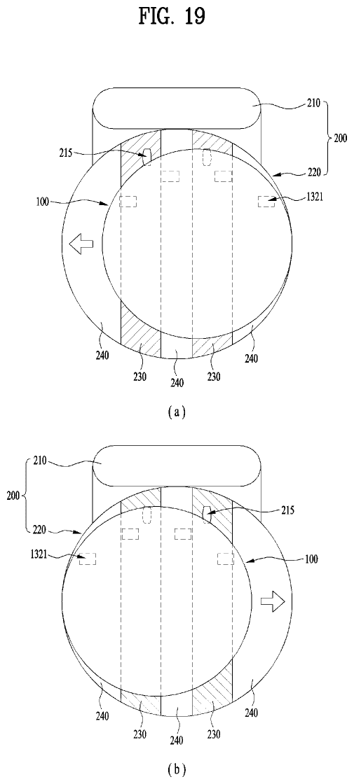

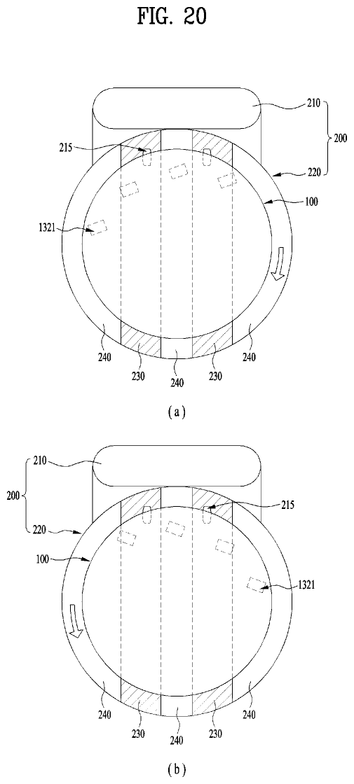

FIG. 18 is a plan view for explaining a state in which the robot cleaner 100 is arranged in a correct position on the robot cleaner charging device 200, FIG. 19 is a plan view showing a state in which the center line of the robot cleaner 100 and the center line of the robot cleaner charging device 200 are not aligned, and FIG. 20 is a plan view for explaining a state in which a difference in direction angle occurs between the robot cleaner 100 and the robot cleaner charging device 200.

The robot cleaner 100 shown in FIGS. 18 to 20 is similar to the robot cleaner 100 shown in FIGS. 6 to 8 except that the number of each of the first cliff detection sensors 1321 and the second cliff detection sensors 1322 is different, and the robot cleaner charging device 200 shown in FIGS. 18 to 20 is similar to the robot cleaner charging device 200 shown in FIGS. 6 to 8 except for pattern shapes of the first pad 230 and the second pad 240. Accordingly, a detailed description of the same content among the robot cleaner 100 and the robot cleaner charging device 200 will be omitted.

Referring to FIGS. 18 to 20, the cliff detection sensor 132 of the robot cleaner 100 may include four first cliff detection sensors 1321 for detecting obstacles in front of the bottom surface part, and the array plate 220 of the robot cleaner charging device 200 may include two first pads 230 formed to respectively cross specific portions of the array plate 220 and three second pads 240 formed to cover both sidewalls of the first pad 230. In this case, the cliff detection sensor 132 of the robot cleaner 100 may not include the second cliff detection sensor 1322 for detecting obstacles behind the bottom surface part, but the concept of the present disclosure is not necessarily limited thereto. That is, the cliff detection sensor 132 of the robot cleaner 100 may further include one or more second cliff detection sensors 1322.

In exemplary embodiments, the second pad 240 formed on the left side of the array plate 220 and the second pad 240 formed on the right side of the array plate 220 may have the same width, and the second pad 240 formed in the center of the array plate 220 may have a smaller width than these. In one embodiment, the two first pads 230 may have the same width, and may have widths that are smaller than the second pad 240 formed on the left side of the array plate 220 and the second pad 240 formed on the right side of the array plate 220 and are larger than the second pad 240 formed in the center of the array plate 220.

In this case, the robot cleaner 100 may determine a state in which all signal values received by the two cliff detection sensors 132 provided on the right and left sides are each ‘1’ and all signal values received by the two cliff detection sensors 132 disposed therebetween are each ‘0’ as a state in which the center line of the robot cleaner 100 and the center line of the robot cleaner charging device 200 are aligned.

In detail, as shown in FIG. 18, the robot cleaner 100 may determine a state in which the two first cliff detection sensor 1321 provided on the right and left sides are located on the second pad 240 and all the first cliff detection sensors 1321 provided therebetween are located on the first pad 230 as a state in which the center line of the robot cleaner 100 and the center line of the robot cleaner charging device 200 are aligned.

The robot cleaner 100 may determine the following state as a state in which the center line of the robot cleaner 100 and the center line of the robot cleaner charging device 200 are not aligned or a difference in direction angle occurs between the robot cleaner 100 and the robot cleaner charging device 200.

For example, as shown in FIG. 19(a), the robot cleaner 100 may determine a state in which signal values received by the first cliff detection sensors 1321 are ‘10’, ‘1’, ‘0’ and ‘1’ sequentially from the left as a state in which the robot cleaner 100 is arranged on the right side on the array plate 220 of the robot cleaner charging device 200. In this case, a signal value received by the first cliff detection sensor 1321 provided on the leftmost side may be ‘0’.

In this case, the robot cleaner 100 may be controlled to move to the left, and accordingly, the center line of the robot cleaner 100 and the center line of the robot cleaner charging device 200 may be aligned.

For example, as shown in FIG. 19(b), the robot cleaner 100 may determine a state in which signal values received by the first cliff detection sensors 1321 are ‘1’, ‘0’, ‘1’, and ‘01’ sequentially from the left as a state in which the robot cleaner 100 is arranged on the right side on the array plate 220 of the robot cleaner charging device 200. In this case, a signal value received by the first cliff detection sensor 1321 provided on the rightmost side may be ‘0’.

In this case, the robot cleaner 100 may be controlled to move to the right, and accordingly, the center line of the robot cleaner 100 and the center line of the robot cleaner charging device 200 may be aligned.

For example, as shown in FIG. 20(a), the robot cleaner 100 may determine a state in which signal values received by the first cliff detection sensors 1321 are ‘1’, ‘10’, ‘1’, and ‘01’ sequentially from the left as a state in which a difference in direction angle in a counterclockwise direction occurs between the robot cleaner 100 and the robot cleaner charging device 200.

In this case, the robot cleaner 100 may be controlled to rotate in a clockwise direction, and accordingly, a difference in direction angle between the robot cleaner 100 and the robot cleaner charging device 200 may be corrected.

For example, as shown in FIG. 20(b), the robot cleaner 100 may determine a state in which signal values received by the first cliff detection sensors 1321 are ‘10’, ‘1’, ‘01’, and ‘1’ sequentially from the left as a state in which a difference in direction angle in a clockwise direction occurs between the robot cleaner 100 and the robot cleaner charging device 200.

In this case, the robot cleaner 100 may be controlled to rotate in a counterclockwise direction, and accordingly, a difference in direction angle between the robot cleaner 100 and the robot cleaner charging device 200 may be corrected.

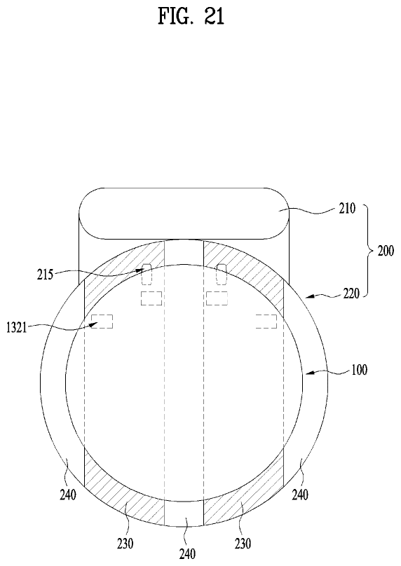

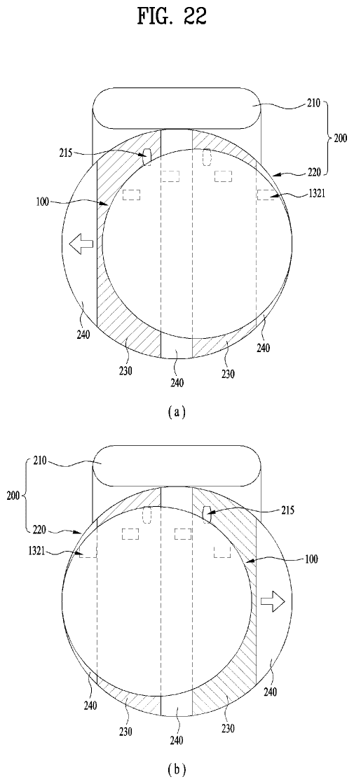

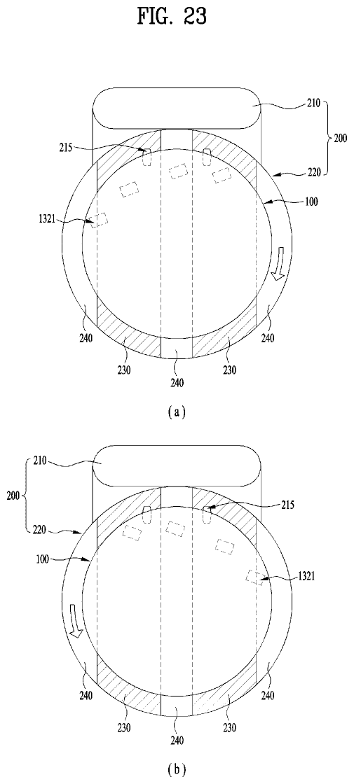

FIG. 21 is a plan view for explaining a state in which the robot cleaner 100 is arranged in a correct position on the robot cleaner charging device 200, FIG. 22 is a plan view showing a state in which the center line of the robot cleaner 100 and the center line of the robot cleaner charging device 200 are not aligned, and FIG. 23 is a plan view for explaining a state in which a difference in direction angle occurs between the robot cleaner 100 and the robot cleaner charging device 200.

The robot cleaner 100 shown in FIGS. 21 to 23 is similar to the robot cleaner 100 shown in FIGS. 6 to 8 except that the number of each of the first cliff detection sensors 1321 and the second cliff detection sensors 1322 is different, and the robot cleaner charging device 200 shown in FIGS. 15 to 17 is similar to the robot cleaner charging device 200 shown in FIGS. 21 to 23 except for pattern shapes of the first pad 230 and the second pad 240. Accordingly, a detailed description of the same content among the contents of the robot cleaner 100 and the robot cleaner charging device 200 will be omitted.

Referring to FIGS. 21 to 23, the cliff detection sensor 132 of the robot cleaner 100 may include four first cliff detection sensors 1321 for detecting obstacles in front of the bottom surface part, and the array plate 220 of the robot cleaner charging device 200 may include two first pads 230 formed to respectively cross specific portions of the array plate 220 and three second pads 240 formed to cover both sidewalls of the first pad 230. In this case, the cliff detection sensor 132 of the robot cleaner 100 may not include the second cliff detection sensor 1322 for detecting obstacles behind the bottom surface part, but the concept of the present disclosure is not limited thereto. That is, the cliff detection sensor 132 of the robot cleaner 100 may further include one or more second cliff detection sensors 1322.

In exemplary embodiments, the second pad 240 formed on the left side of the array plate 220 and the second pad 240 formed on the right side of the array plate 220 may have the same width, and the second pad 240 formed in the center of the array plate 220 may have a smaller width than these. In one embodiment, the two first pads 230 may have the same width, and may have a larger width of each of the three second pads 240.

In this case, the robot cleaner 100 may determine a state in which all signal values received by the cliff detection sensors 132 are each ‘0’ as a state in which the center line of the robot cleaner 100 and the center line of the robot cleaner charging device 200 are aligned.

In detail, as shown in FIG. 21, the robot cleaner 100 may determine a state in which all the first cliff detection sensors 1321 are located only on the first pad 230, but not on the second pad 240 as a state in which the center line of the robot cleaner 100 and the center line of the robot cleaner charging device 200 are aligned.

The robot cleaner 100 may determine a state in which at least one of signal values received by the cliff detection sensors 132 is ‘01’, ‘10’, or ‘1’ as a state in which the center line of the robot cleaner 100 and the center line of the robot cleaner charging device 200 are not aligned or a difference in direction angle occurs between the robot cleaner 100 and the robot cleaner charging device 200.

For example, as shown in FIG. 22(a), the robot cleaner 100 may determine a state in which signal values received by the first cliff detection sensors 1321 are ‘0’, ‘1’, ‘0’, and ‘1’ sequentially from the left as a state in which the robot cleaner 100 is arranged on the right side on the array plate 220 of the robot cleaner charging device 200.

In this case, the robot cleaner 100 may be controlled to move to the left, and accordingly, the center line of the robot cleaner 100 and the center line of the robot cleaner charging device 200 may be aligned.

For example, as shown in FIG. 22(b), the robot cleaner 100 may determine a state in which signals received by the first cliff detection sensors 1321 are ‘1’, ‘0’, ‘1’, and ‘0’ sequentially from the left as a state in which the robot cleaner 100 is arranged on the right side on the array plate 220 of the robot cleaner charging device 200.

In this case, the robot cleaner 100 may be controlled to move to the right, and accordingly, the center line of the robot cleaner 100 and the center line of the robot cleaner charging device 200 may be aligned.

For example, as shown in FIG. 23(a), the robot cleaner 100 may determine a state in which signals received by the first cliff detection sensors 1321 are ‘10’, ‘0’, ‘1’, and ‘0’ sequentially from the left as a state in which a difference in direction angle in a counterclockwise direction occurs between the robot cleaner 100 and the robot cleaner charging device 200.

In this case, the robot cleaner 100 may be controlled to rotate in a clockwise direction, and accordingly, a difference in direction angle between the robot cleaner 100 and the robot cleaner charging device 200 may be corrected.

For example, as shown in FIG. 23(b), the robot cleaner 100 may determine a state in which signals received by the first cliff detection sensors 1321 are ‘0’, ‘1’, ‘0’, and ‘01’ sequentially from the left as a state in which a difference in direction angle in a clockwise direction occurs between the robot cleaner 100 and the robot cleaner charging device 200.

In this case, the robot cleaner 100 may be controlled to rotate in a counterclockwise direction, and accordingly, a difference in direction angle between the robot cleaner 100 and the robot cleaner charging device 200 may be corrected.

As described above, the robot cleaner 100 may include the plurality of cliff detection sensors 132 and may receive different signals through the plurality of cliff detection sensors 132 according to pattern shapes of the plurality of pads 230 and 240 formed on the array plate 220 in a state in which the robot cleaner 100 and the robot cleaner charging device 200 are in close proximity.

Thus, the center line of the robot cleaner 100 and the center line of the robot cleaner charging device 200 may be aligned, a difference in direction angle between the robot cleaner 100 and the robot cleaner charging device 200 may be corrected, and docking for charging may be performed more precisely in a state where the robot cleaner 100 and the robot cleaner charging device 200 are in close proximity.

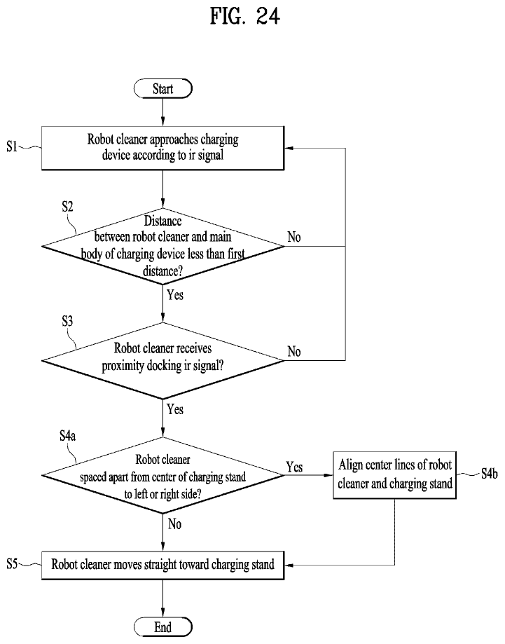

FIG. 24 is a flowchart for explaining a method of aligning center lines using a robot cleaner charging device according to an embodiment of the present disclosure.

Referring to FIG. 24, a control method of a robot cleaner using a robot cleaner charging device according to the present disclosure may include a first operation S1 in which the robot cleaner 100 approaches the robot cleaner charging device 200 through an IR signal, a second operation S2 of checking whether a distance between the robot cleaner 100 and the robot cleaner charging device 200 is less than a first distance D1, a third operation S3 of checking whether the robot cleaner 100 receives a proximity docking IR signal generated from the robot cleaner charging device 200, a fourth operation S4 of checking whether the center lines of the robot cleaner 100 and the robot cleaner charging device 200 are aligned through the cliff detection sensor 132 (S4a) and aligning the center lines (S4b), and a fifth operation S5 in which the robot cleaner 100 moves straight toward the robot cleaner charging device 200 when the center lines of the robot cleaner 100 and the robot cleaner charging device 200 are aligned.

In this case, the robot cleaner charging device 200 may include different types of pads that are alternately and repeatedly disposed, for example, the first pad 230 and the second pad 240 having different colors or upper surfaces with different heights, and the fourth operation S4 may be performed by allowing the robot cleaner 100 to detect the position of each of the first pad 230 and the second pad 240 through the cliff detection sensor 132 and to move to the left or right side.

In this case, the first operation S1 may be referred to as a remote docking operation, and the second operation S2 to the fifth operation S5 may be referred to as a center line alignment operation.

In exemplary embodiments, the first distance D1 may be about 30 cm.

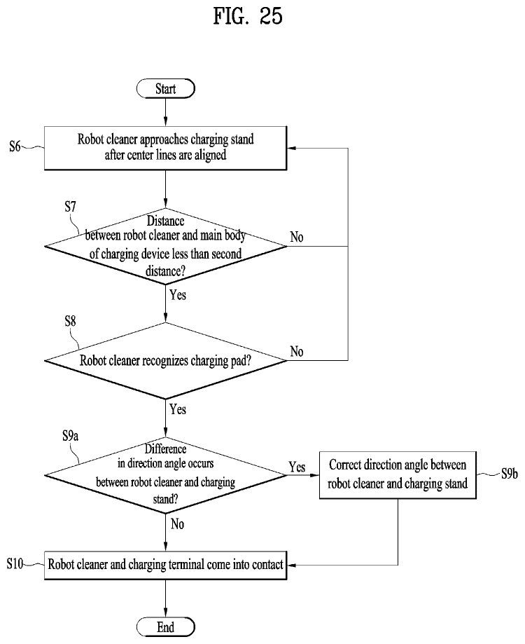

FIG. 25 is a flowchart for explaining a method of correcting a direction angle using a robot cleaner charging device according to an embodiment of the present disclosure.

Referring to FIG. 25, a control method of a robot cleaner using a robot cleaner charging device according to the present disclosure may further include a sixth operation S6 in which the robot cleaner 100 approaches the robot cleaner charging device 200 after the center line alignment operation, a seventh operation S7 of checking whether a distance between the robot cleaner 100 and the robot cleaner charging device 200 is less than a second distance D2 that is smaller than the first distance D1, an eighth operation S8 of checking whether the robot cleaner 100 recognizes the pads 230 and 240 through the cliff detection sensor 132, a ninth operation S9 of checking whether a difference in direction angle occurs between the robot cleaner 100 and the robot cleaner charging device 200 through the cliff detection sensor 132 (S9a) and correcting the direction angle difference (S9b), and a tenth operation S10 in which the robot cleaner 100 and the charging terminal 215 come into contact when the direction angles of the robot cleaner 100 and the robot cleaner charging device 200 are corrected.

In this case, the sixth operation S6 to the tenth operation S10 may be referred to as a direction angle correction operation, and the second operation S2 to the tenth operation S10 may be referred to as a short-distance docking operation together.

In exemplary embodiments, the second distance D1 may be about 15 cm.

As described above, the remote docking operation of the robot cleaner 100 may be performed according to the IR signal generated from the robot cleaner charging device 200, and the short-distance docking operation of the robot cleaner 100 may be performed through the cliff detection sensor 132, the first pad 230, and the second pad 240.

That is, docking in a state in which the robot cleaner 100 is in close proximity to the robot cleaner charging device 200 may not be performed according to an IR signal, and thus may not be affected by external environments, such as indoor lighting and sunlight, and a disadvantage that it is difficult to distinguish a specific area of the robot cleaner charging device 200 according to the maximum intensity of the IR signal may be overcome. Accordingly, short-distance docking for charging the robot cleaner 100 and the robot cleaner charging device 200 may be precisely performed.

Although various embodiments of the present disclosure have been described in detail above, those of ordinary skill in the art to which the present disclosure pertains will understand that it is possible to make various modifications to the above-described embodiments without departing from the scope of the present disclosure. Therefore, the scope of the present disclosure should not be limited to the described embodiments, and should be defined by the claims described below as well as the claims and equivalents.

1. A robot cleaner charging device comprising:
a main body defining an outer appearance and provided to charge a robot cleaner including a plurality of cliff detection sensors; and
an array plate defining a lower part of the main body and having an upper surface on which a charging terminal for charging the robot cleaner is provided,
wherein a plurality of pads provided to allow the robot cleaner to receive different signals through the plurality of cliff detection sensors are formed on the upper surface of the array plate.

2. The robot cleaner charging device of claim 1, wherein the plurality of pads include a first pad and a second pad, and the first pad and the second pad are alternately and repeatedly disposed.

3. The robot cleaner charging device of claim 2, wherein the first pad and the second pad have upper surfaces with the same height and have different colors.

4. The robot cleaner charging device of claim 3, wherein the first pad has black color and the second pad has white color.

5. The robot cleaner charging device of claim 4, wherein light generated from the plurality of cliff detection sensors toward the first pad is absorbed by the first pad, and light generated from the plurality of cliff detection sensors toward the second pad is reflected by the second pad.

6. The robot cleaner charging device of claim 2, wherein the first pad is provided in one, the second pad is provide in two, and the first pad has a larger width than the second pad.

7. The robot cleaner charging device of claim 2, wherein the first pad is provided in one, the second pad is provide in two, and the first pad has a smaller width than the second pad.

8. The robot cleaner charging device of claim 2, wherein the first pad is provided in two, the second pad is provided in three, and the two first pads have the same width.

9. The robot cleaner charging device of claim 8, wherein the second pad disposed at a center of the array plate among the three second pads has a smaller width than the first pad, and the second pads at both edges of the array plate among the three second pads each have a smaller width than the first pad.

10. The robot cleaner charging device of claim 8, wherein the three second pads each have a smaller width than the first pad.

11. The robot cleaner charging device of claim 2, wherein the first pad is provided in three, the second pad is provided in two, and the two second pads have the same width.

12. The robot cleaner charging device of claim 11, wherein a first pad disposed at a center of the array plate among the three first pads has a smaller width than the second pad, and first pads disposed at both edges of the array plate among the three first pads each have a smaller width than the second pad.

13. The robot cleaner charging device of claim 11, wherein the three first pads each have a smaller width than the second pad.

14. The robot cleaner charging device of claim 5, wherein the plurality of cliff detection sensors include a plurality of first cliff detection sensors for detecting an obstacle in front, and in a state in which center lines of center lines of the robot cleaner and the main body are aligned, the plurality of first cliff detection sensors are arranged only on one type of pad among the first pad and the second pad.

15. The robot cleaner charging device of claim 14, wherein, in a state in which the center lines of the robot cleaner and the main body are aligned, some of the plurality of first cliff detection sensors are arranged on the first pad, and the others of the plurality of first cliff detection sensors are arranged on the second pad.

16. The robot cleaner charging device of claim 14, wherein the plurality of cliff detection sensors include a plurality of second cliff detection sensors for detecting an obstacle behind, and in a state in which the center lines of the robot cleaner and the main body are aligned, the plurality of second cliff detection sensors and the plurality of first cliff detection sensors are arranged together on one type of pad among the first pad and the second pad.

17. A robot cleaner charging device comprising:
a main body defining an outer appearance and provided to charge a robot cleaner including a plurality of cliff detection sensors; and
an array plate defining a lower part of the main body and having an upper surface on which a charging terminal for charging the robot cleaner is provided,
wherein a plurality of pads provided to allow the robot cleaner to receive different signals through the plurality of cliff detection sensors are formed on the upper surface of the array plate, and
wherein the plurality of pads have the same color and have upper surfaces with different heights.

18. The robot cleaner charging device of claim 17, wherein the plurality of pads include a first pad and a second pad having an upper surface having a lower height than an upper surface of the first pad, and the first pad and the second pad are alternately and repeatedly disposed.

19. A control method of a robot cleaner using a robot cleaner charging device, the method comprising:
a first operation in which a robot cleaner including a cliff detection sensor approaches the robot cleaner charging device including a charging terminal for charging the robot cleaner and different types of pads through an IR signal;
a second operation of checking whether a distance between the robot cleaner and the robot cleaner charging device is less than a first distance;
a third operation of checking whether the robot cleaner receives a proximity docking signal generated from the robot cleaner charging device;
a fourth operation of checking whether center lines of the robot cleaner and the robot cleaner charging device are aligned through the cliff detection sensor and aligning the center lines;
a fifth operation in which the robot cleaner moves straight toward the robot cleaner charging device when the center lines of the robot cleaner and the robot cleaner charging device are aligned;
a sixth operation in which the robot cleaner approaches the robot cleaner charging device after the center lines are aligned;
a seventh operation of checking the distance between the robot cleaner and the robot cleaner charging device is less than a second distance smaller than the first distance;
an eighth operation of checking whether the robot cleaner recognizes the pads through the cliff detection sensor;
a ninth operation of checking whether a difference in direction angle occurs between the robot cleaner and the robot cleaner charging device through the cliff detection sensor and correcting the difference in direction angle; and
a tenth operation in which the robot cleaner and the charging terminal come into contact when the direction angles of the robot cleaner and the robot cleaner charging device are corrected.

20. The method of claim 19, wherein the pads include a first pad and a second pad that are alternately and repeatedly disposed, the first pad and the second pad have different colors or have upper surfaces with different heights, the fourth operation is performed by allowing the robot cleaner to detect a position of each of the first pad and the second pad through the cliff detection sensor and to move to a left or right side, and the ninth operation is performed by allowing the robot cleaner to detect a position of each of the first pad and the second pad through the cliff detection sensor and to rotate in a clockwise or counterclockwise direction.
